(19) United States
(12) Patent Application Publication
(10) Pub. No.: US 2016/0293071 A1
(43) Pub. Date: Oct. 6, 2016

(54) BANNER

(71) Applicant: Wayne Gary Shoveller, Sheerness (GB)

(72) Inventor: Wayne Gary Shoveller, Sheerness (GB)

(21) Appl. No.: 15/093,571

(22) Filed: Apr. 7, 2016

Related U.S. Application Data
(63) Continuation of application No. 14/166,455, filed on Jan. 28, 2014, now abandoned.

(30) Foreign Application Priority Data
Feb. 4, 2013 (GB) 1301934.4

(51) Int. Cl. G09F 17/00; G09F 13/18; G09F 13/10; G09F 13/06; G09F 13/08

(52) U.S. Cl. CPC G09F 17/00; G09F 13/06; G09F 13/08; G09F 13/10; G09F 13/18; G09F 2017/0041; G09F 2013/1854; G09F 2013/222

(57) ABSTRACT

The invention provides a banner comprising:
a strip (1) of flexible material bearing a sequence of letters or numbers or other characters which together constitute a message;
one or more light sources mounted on or behind the banner so as to illuminate the message;
a source of electrical power for the light sources; and
one or more switches for switching the light sources on or off.

This application is a continuation of U.S. application Ser. No. 14/166,455, filed on Jan. 28, 2014, which claims priority to GB Application No. 1301934.4, filed on Feb. 4, 2013, and published on Aug. 7, 2013 as GB 2499126 A. The entire contents of each of the prior applications are incorporated herein by reference.

Greetings banners have become increasingly popular in recent years and are often put up in homes to celebrate an event such as a birthday.

This invention provides an improved greetings banner in which the message carried by the banner is illuminated.

Accordingly, the invention provides a banner comprising:

a strip of flexible material bearing a sequence of letters or numbers or other characters which together constitute a message;

one or more light sources mounted on or behind the banner so as to illuminate the message;

a source of electrical power for the light sources; and

one or more switches for switching the light sources on or off.

The strip of flexible material is typically sufficiently flexible that it can be rolled up or folded, for example for packaging purposes or for storage. The flexible material may therefore be a plastics film or cloth, or a woven or non-woven fabric, or paper or light card.

The strip of flexible material bears a sequence of letters or numbers or other characters which together constitute a message. In addition to the message, the strip of flexible material may also bear one or more images, symbols or logos which are also illuminated.

The banner may be provided as a single entity or as a plurality of banners separably linked together. For example, two or more banners may be linked together with a line or perforations between them so that they may be separated prior to use. The group of linked banners may be folded along the lines of perforations to provide a more compact package.

The light sources advantageously are LED devices such as LED bulbs.

In one embodiment, the light source(s) can be, for example, an array of LED devices mounted on the strip of flexible material, the array being configured to present an illuminated message.

In another and preferred embodiment, the strip of flexible material has one or more windows along its length, the windows being shaped so as to form letters or numbers or other characters which together constitute a message, and the light source(s) is/are positioned behind the strip of flexible material and windows and is/are arranged so as to illuminate the windows.

In one particular embodiment, the invention provides a banner comprising:

a strip of flexible material having one or more windows along all or part of its length, the windows being shaped so as to form letters or numbers or other characters which together constitute a message;

one or more light sources being disposed behind the strip of flexible material; and

a flexible light guide extending along the banner behind the windows, the flexible light guide being arranged to convey light from the one or more light sources to the windows so as to illuminate the message;

a source of electrical power for the light sources; and

one or more switches for switching the light sources on or off.

Where the letters, numbers or other characters are defined by windows in the strip of flexible material, the window may take the form of holes in the flexible material and/or they may take the form of transparent or translucent regions of the flexible material.

The transparent or translucent regions of the flexible material may be coloured so that the message shows up in one or more colours.

The light sources may provide constant (i.e. non-flashing) light or they may be arranged to provide pulses of light (i.e. they may be flashing lights). In one preferred embodiment, the light sources provide a flashing light.

When the light sources comprise or consist of LEDs, the LEDs can collectively emit light of a single colour or more than one colour. For example, they may be arranged so as to flash different colours.

Where a flexible light guide is employed, it may take the form of, for example, a flexible light tube which conveys the light from the light source to the windows. In one embodiment, the light source is disposed at one end of the banner and a light guide (e.g. light tube) extends along the banner behind the strip of flexible material.

The light tube is formed from a flexible material such as a flexible plastics (e.g. polyethylene) film. The flexible material may be wholly transparent or may be coloured, at least in part.

In a preferred embodiment, the banner comprises a pair of strips of flexible material attached together along their lengths so as to form front and rear panels, wherein the light sources and any light guides when present are disposed between the panels.

The terms “front” and “rear” in the context of the present invention refer to the direction from which the banner is viewed. Thus, the front surface is the surface on which the message is visible and the rear surface is the surface facing away from the message. In one embodiment of the invention, the banner is provided on both surfaces with an array of letters or other characters constituting a message and optionally one or more images, in which case each surface could be regarded as the front or the back depending on the orientation of the banner in use.

The source of power for the light sources may be a connector for connecting to an external power source such as a mains supply or transformer but, more preferably, the power source is a battery. Where the banner has front and rear panels, the battery is typically located between the panels.

The switch for switching the light sources on and off is typically arranged so that at least a main body of the switch is behind the strip of flexible material (or between the front and rear panels when there are two strips forming such panels). The switch may be wholly behind the strip of flexible material (or between the two panels) or an actuatable arm or lever of the switch may protrude through and forwardly of the strip.

In addition to carrying an illuminated message, the banner can also be provided with a sound module. The sound module can provide a musical accompaniment for the message, for example a short musical composition, song or jingle.

Alternatively, or additionally, the sound module can carry a voice message, for example a voice message directed specifically to a recipient or viewer of the banner.

In another embodiment, the invention provides a banner as defined herein, the banner comprising:

first and second panels formed of a flexible material and connected together so as to enclose an interior space;

at least one of the panels having a plurality of windows, the windows being shaped so as to form letters or numbers or other characters which together constitute a message;

a substantially transparent flexible protective sleeve disposed within the interior space and extending along a greater part of the length of the interior space;

a plurality of light sources disposed within the protective sleeve, the light sources being spaced apart so as to span the greater part of the length of the protective sleeve and being positioned so as to illuminate the message;

a source of electrical power for the light sources; and

one or more switches for switching the light sources on or off.

The letters, numbers or other characters are defined by windows in the flexible material and the window may take the form of holes in the flexible material and/or they may take the form of transparent or translucent regions of the flexible material. For example, the windows may be defined by transparent regions of the flexible material along all or part of its length.

The transparent or translucent regions of the flexible material may be coloured so that the message shows up in one or more colours.

The first and second panels are typically formed of a plastics film and are typically joined together around their respective peripheries.

The first and second panels may be constituted by separate sheets of material joined together, or they may be constituted by a single sheet of material folded over to form two panels which are secured at the edges thereof.

The two panels may be connected together by means of adhesive bonding or by heat sealing, for example.

A first of the panels may be provided with an array of windows and a second of the panels may be provided with an inwardly facing reflective surface so as to reflect light from the light sources towards the windows.

The light sources are preferably LED lights, as hereinbefore defined. Thus they may be flashing or non-flashing, and/or of a single colour or multiple colours, as hereinbefore defined. In one particular embodiment, at least some of the LED lights (e.g. all of the LED lights) are arranged to flash on and off. The LED lights may be connected together so as to form a chain that extends along the greater part of the interior of the protective sleeve. The LED lights are positioned so that they illuminate the windows forming the letters or numbers or other characters which together constitute the message. Preferably, at least some of the light sources (e.g. LEDs) are aligned with the windows.

There may be, for example, between five and thirty LEDs more typically between eight and twenty LEDs linked to form a chain.

The protective sleeve may be formed, for example from a transparent or translucent (preferably transparent) plastics material. For example, the protective sleeve may be formed from a length of flattened extruded plastics film material such as polyethylene. Alternatively, the protective sleeve may be formed from a length of transparent or translucent plastics film material that has been folded along a longitudinal fold line and the opposed edges heat sealed together along their length. In a further embodiment, the protective sleeve may comprise a length of transparent or translucent plastics material formed into a roll which extends longitudinally along the interior space.

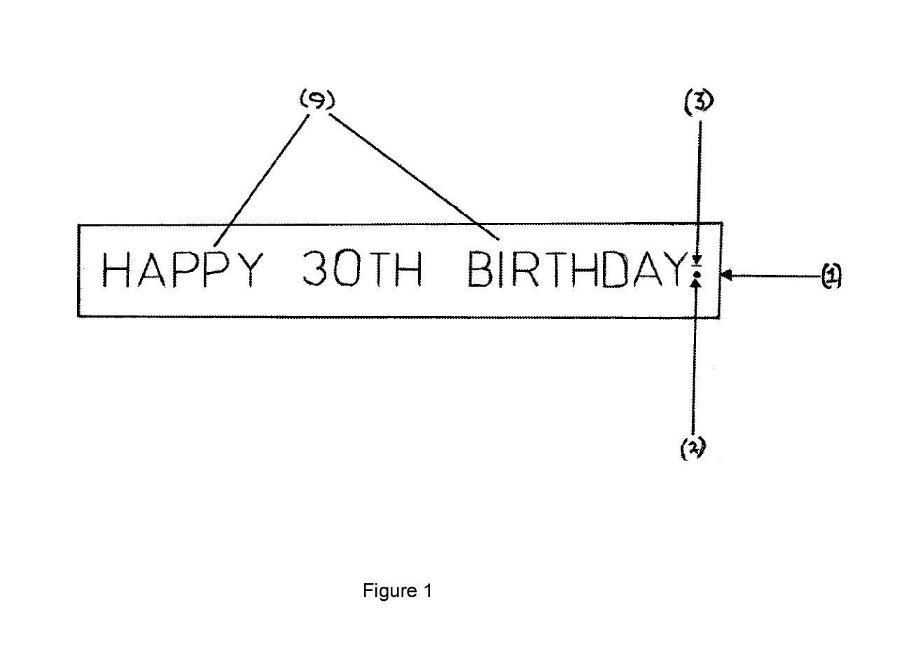

The invention will now be described in more detail, but not limited, by reference to the specific embodiments illustrated in the accompanying drawings FIGS. 1 to 6.

FIG. 1 is a view from one side of a banner according to one embodiment of the invention.

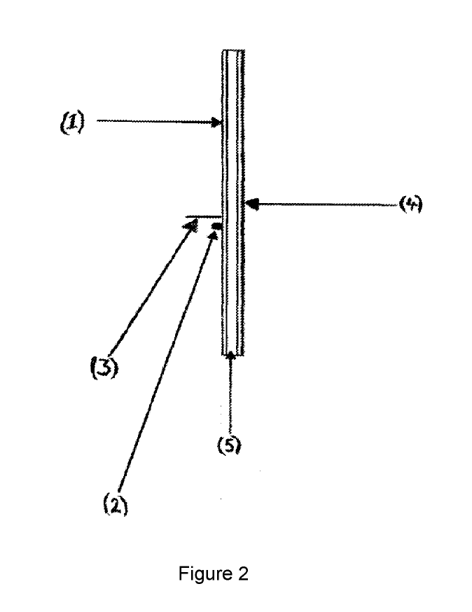

FIG. 2 is a sectional elevation along line I-I in FIG. 1.

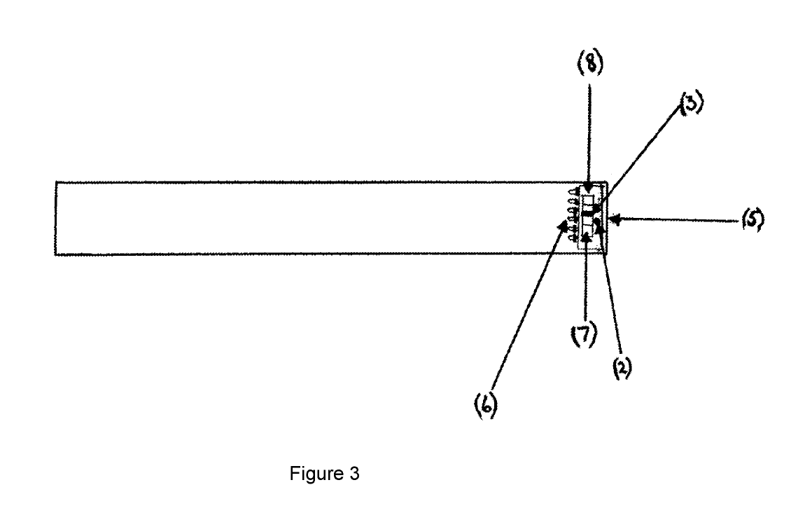

FIG. 3 is a view of a light tube and light source forming part of the banner of FIGS. 1 and 2.

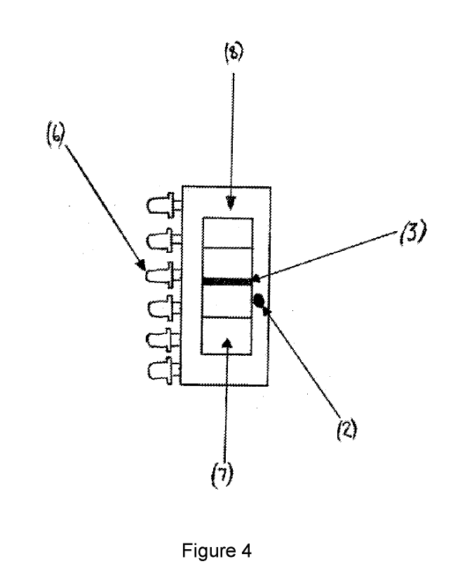

FIG. 4 is an enlarged view of the light source of FIG. 4.

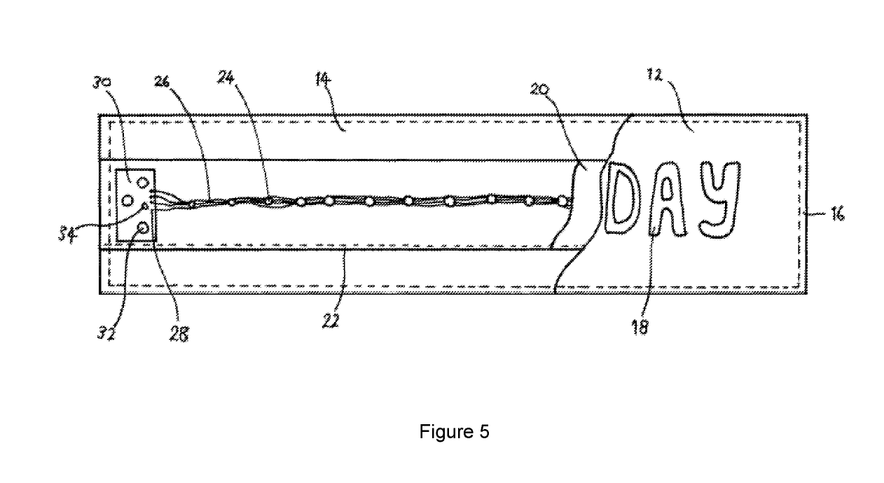

FIG. 5 is a partially cut-away view of a banner according to a second embodiment of the invention.

Referring to the drawings, a banner according to one aspect of the invention comprises front (1) and rear (4) panels formed from a flexible plastics sheet or film material such as polyethylene sheet. At least the front panel (1) and preferably also the rear panel (4) are formed from a relatively opaque sheet provided with windows (9) in the shape of letters and numbers. In the embodiment shown, the letters and numbers form the message “Happy 30th Birthday”, but it will be appreciated that alternative messages such as “Congratulations on your exam success” and “Happy Christmas” may be formed instead.

The windows may be defined by holes cut into the front panel (1). Alternatively, they may be defined by light transmitting (e.g. transparent or translucent) regions of the plastics sheet.

Sandwiched between the front (1) and rear (4) panels is a light tube (5) which in this embodiment is a flattened flexible tube formed from transparent plastics sheet or film material. The tube may be an extruded tube or may be formed from a flat length of plastics sheet material folded round to form a flattened cylinder and the longitudinal edges overlapped and bonded together.

At one end of the light tube (5) is a light source (6) comprising an array of LED bulbs connected to a circuit board (8), an on-off switch (2), a tag activator (3) and one or more batteries (7). An actuating lever of the switch (2) protrudes through the front panel (1) of the banner as does an end of the tag activator (3). The inner end of the tag activator sits between two electrical contacts and prevents premature activation of the battery. Pulling out the tag activator (3) allows the electrical contacts to touch thereby completing an electrical circuit and allowing the lights to be switched on. Instead of using a switch having an actuating lever which protrudes through the panel (1), the switch may be of the push-button type and may be concealed wholly within a space between the front (1) and rear (4) panels.

In the embodiment illustrated in the drawings, the illumination of the message is provided by means of a light tube located behind windows in the banner. As an alternative, the message can be defined by means of an array or line of LEDs mounted on the banner material.

The banner may be provided with mounting points (e.g. eyelets) for attaching the banner to an object or surface, e.g. by hooks or using cord. Alternatively, the banner may be provided with one or more peelable adhesive areas which may be used to secure the banner to a surface. The peelable adhesive areas are typically protected with a release paper (e.g. a silicone coated release paper) which may be removed before use and then replaced when the banner is taken down for storage.

A banner according to a second embodiment of the invention is shown in FIG. 5 which is a partially cut away front view of the banner.

As shown in FIG. 5, the banner comprises front (12) and rear (14) panels formed from plastics film which are heat sealed together around their peripheries (16) to enclose an interior space. The front panel (12) is relatively opaque over much of its surface area but is provided with windows defined by clear regions shaped to form letters making up a message such as “Happy Birthday”. The rear panel (14) has no windows but has an inwardly facing reflective surface. Mounting points (not shown) may be provided at either end of the banner to enable it to be fixed to a wall or other mounting location.

A sleeve (20) formed from a relatively tough transparent plastics film extends along the interior space and is anchored in the heat seals (16) at either end of the banner. Alternatively, it can be arranged loosely and without anchoring within the interior space. The sleeve (20) can be formed from a pair of elongate sheets heat sealed together around their peripheries or it can be formed from a single strip of plastics film folded over with the opposed edges heat sealed together.

In FIG. 5, the protective sleeve (20) is shown as having a wall of single thickness. However, in order to enhance its protective properties, the protective sleeve can have a multi-layer wall. For example, in one embodiment, a sleeve having a multi-layered wall can be formed from a single elongate strip of plastics material rolled about a longitudinal axis into a flattened coil.

Arranged inside and protected by the protective sleeve (20) is a chain of LED lights (24) linking by wiring (26). The wires from the LED are connected via soldered connections to a printed circuit board (30) which controls the operation of the LED lights. Mounted on the printed circuit board (30) are an on-off switch (34) and battery housings (32) in which are held “button cell” batteries. Plastic pull-out strips (not shown) can be positioned between each battery and an adjacent electrical contact surface to prevent premature activation and loss of power from the batteries.

In use, the pull-out strips are removed from the battery housings and the switch is moved to the “on” position to switch on the LED lights. The lights are typically arranged to flash on and off, although they can alternatively be set up in a non-flashing mode.

The flashing lights light up the windows (18), thereby providing an illuminated message. The reflective inner surface of the rear panel (14) serves to enhance the brightness of the illumination.

It will readily be apparent that numerous modifications and alterations may be made to the specific embodiments of the invention described above without departing from the principles underlying the invention. All such modifications and alterations are intended to be embraced by this application.

1. A banner comprising:
a strip of flexible material bearing a sequence of letters or numbers or other characters which together constitute a message;
one or more light sources mounted on or behind the banner so as to illuminate the message;
a source of electrical power for the light sources; and
one or more switches for switching the light sources on or off.

2. A banner according to claim 1 wherein the one or more light sources are constituted by an array of LED devices.

3. A banner according to claim 1 wherein the strip of flexible material has one or more windows along its length, the windows being shaped so as to form letters or numbers or other characters which together constitute the message, and the light source(s) is/are positioned behind the strip of flexible material and windows and is/are arranged so as to illuminate the windows.

4. A banner according to claim 1 wherein the letters, numbers or other characters are defined by windows in the strip of flexible material.

5. A banner according to claim 4 wherein the windows take the form of holes in the flexible material.

6. A banner comprising:
a strip of flexible material having one or more windows along all or part of its length, the windows being shaped so as to form letters or numbers or other characters which together constitute a message;
one or more light sources being disposed behind the strip of flexible material; and
a flexible light guide extending along the banner behind the windows, the flexible light guide being arranged to convey light from the one or more light sources to the windows so as to illuminate the message;
a source of electrical power for the light sources; and
one or more switches for switching the light sources on or off.

7. A banner according to claim 6 wherein the windows take the form of holes in the flexible material.

8. A banner according to claim 6 wherein the windows take the form of transparent or translucent regions of the flexible material.

9. A banner according to claim 6 wherein the light sources provide a flashing light.

10. A banner according to claim 6 wherein the flexible light guide takes the form of a flexible light tube which conveys the light from the light source to the windows.

11. A banner according to claim 6 which comprises a pair of strips of flexible material attached together along their lengths so as to form front and rear panels, wherein the light sources and any light guides when present are disposed between the panels.

12. A banner according to claim 6 wherein the light source is powered by one or more batteries.

13. A banner comprising:
first and second panels formed of a flexible material and connected together so as to enclose an interior space;
at least one of the panels having a plurality of windows, the windows being shaped so as to form letters or numbers or other characters which together constitute a message;
a substantially transparent flexible protective sleeve disposed within the interior space and extending along a greater part of the length of the interior space;
a plurality of light sources disposed within the protective sleeve, the light sources being spaced apart so as to span the greater part of the length of the protective sleeve and being positioned so as to illuminate the message;
a source of electrical power for the light sources; and
one or more switches for switching the light sources on or off.

14. A banner according to claim 13 wherein the first of the panels is provided with an array of windows and the second of the panels is provided with an inwardly facing reflective surface so as to reflect light from the light sources towards the windows.

15. A banner according to claim 13 wherein the windows take the form of holes in the flexible material.

16. A banner according to claim 13 wherein the windows take the form of transparent regions of the flexible material.

17. A banner according to claim 13 wherein the windows take the form of translucent regions of the flexible material.
